(19) United States
(12) Patent Application Publication
(10) Pub. No.: US 2010/0294859 A1
(43) Pub. Date: Nov. 25, 2010

(54) Gardening Sprinkler Having Angle Adjustable Function

(76) Inventor: Chin-Yuan Chen, Lu Kang Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/468,216

(22) Filed: May 19, 2009

(51) Int. Cl. B05B 1/14

(52) U.S. Cl. 239/548

(57) ABSTRACT

A gardening sprinkler includes a water inlet member having a water inlet channel, a water outlet member pivotally mounted on the water inlet member and having a water outlet channel connected to the water inlet channel of the water inlet member and a spraying head pivotally mounted on the water outlet member and having a plurality of spraying holes each connected to the water outlet channel of the water outlet member. Thus, the water outlet member is rotated relative to the water inlet member, and the spraying head is swiveled relative to the water outlet member so that the spraying head is pivoted relative to the water inlet member in a two-dimensional manner.

### BACKGROUND OF THE INVENTION

1. Field of the Invention

The present invention relates to a sprinkler and, more particularly, to a sprinkler for a gardening purpose.

2. Description of the Related Art

A conventional gardening sprinkler comprises a rigid pipe that is bent to have a determined angle and a spraying head mounted on an upper end of the rigid pipe. The rigid pipe is connected to a water source. When in use, the water from the water source in turn flows through the rigid pipe and the spraying head and is injected outwardly from the spraying holes of the spraying head to sprinkle or water a plant or lawn or to wash an article. However, the rigid pipe is bent to have a determined angle so that the angle of the spraying head cannot be freely adjusted according to a user's requirement, thereby causing inconvenience to the user when operating the gardening sprinkler.

### BRIEF SUMMARY OF THE INVENTION

In accordance with the present invention, there is provided a gardening sprinkler, comprising a water inlet member having a water inlet channel, a water outlet member pivotally mounted on the water inlet member and having a water outlet channel connected to the water inlet channel of the water inlet member and a spraying head pivotally mounted on the water outlet member and having a plurality of spraying holes each connected to the water outlet channel of the water outlet member.

The primary objective of the present invention is to provide a gardening sprinkler having an angle adjustable function.

Another objective of the present invention is to provide a gardening sprinkler whose angle is adjusted in a two-dimensional manner.

A further objective of the present invention is to provide a gardening sprinkler, wherein the water outlet member is rotated relative to the water inlet member, and the spraying head is swiveled relative to the water outlet member so that the spraying head is pivoted relative to the water inlet member in a two-dimensional manner to enhance the maneuverability of the spraying head so as to facilitate a user manipulating the gardening sprinkler.

A further objective of the present invention is to provide a gardening sprinkler, wherein the water outlet member is rotated relative to the water inlet member independently, and the spraying head is swiveled relative to the water outlet member independently so that the user can control the pivot angle and the sprinkling pattern of the spraying head individually.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a gardening sprinkler in accordance with the preferred embodiment of the present invention.

FIG. 2 is an exploded perspective view of the gardening sprinkler as shown in FIG. 1.

FIG. 3 is a side cross-sectional view of the gardening sprinkler as shown in FIG. 1.

FIG. 4 is a partially front cross-sectional view of the gardening sprinkler as shown in FIG. 1.

FIG. 5 is a schematic side operational view of the gardening sprinkler as shown in FIG. 1 in use.

FIG. 6 is a schematic operational view of the gardening sprinkler as shown in FIG. 1 in use.

### DETAILED DESCRIPTION OF THE INVENTION

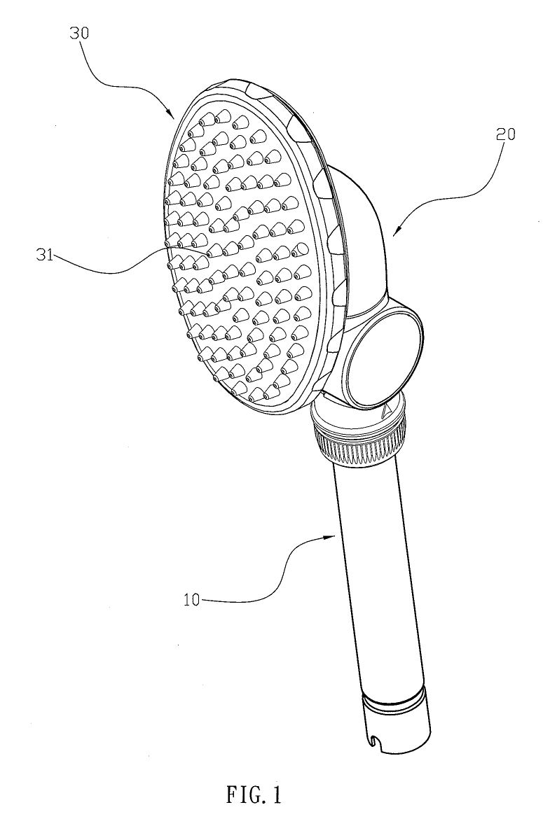

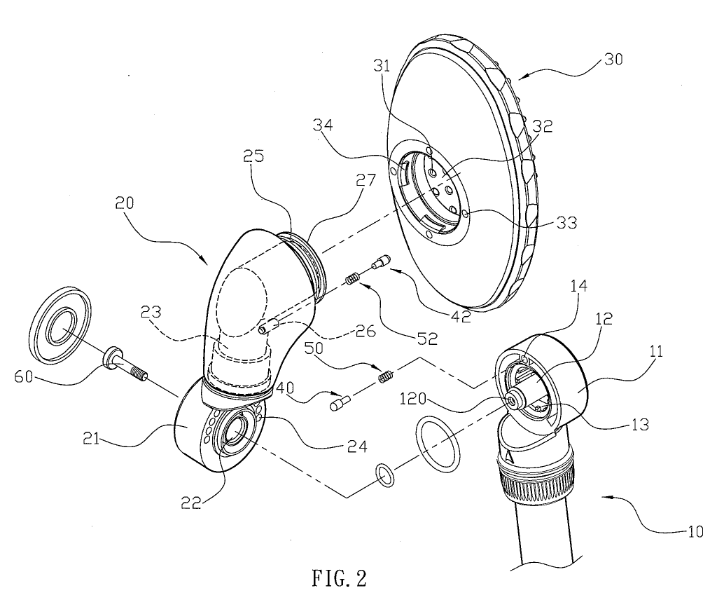

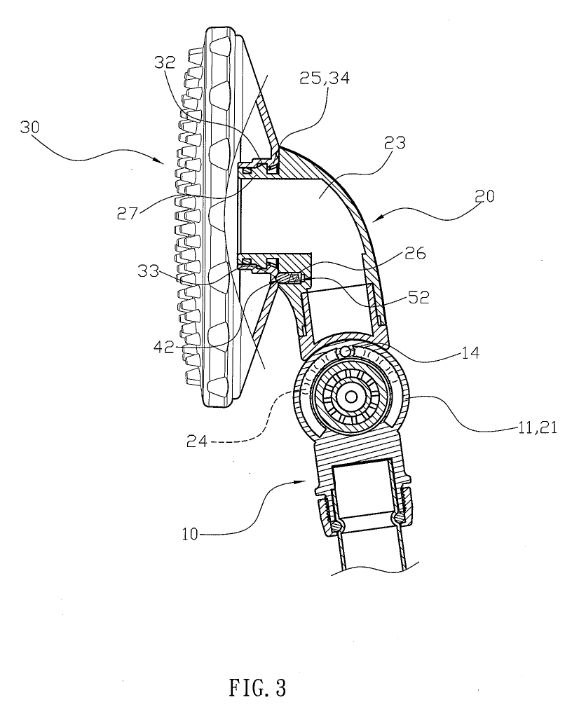

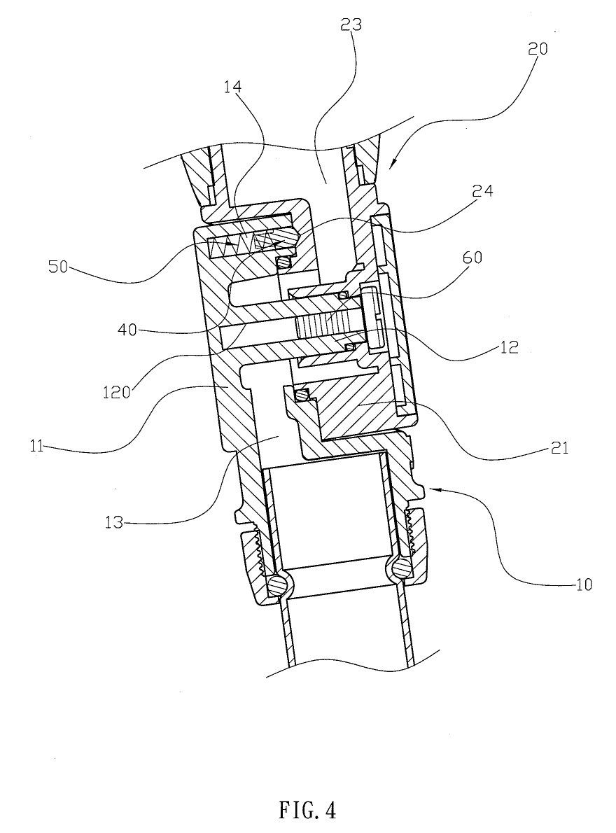

Referring to the drawings and initially to FIGS. 1-4, a gardening sprinkler in accordance with the preferred embodiment of the present invention comprises a water inlet member 10 having a water inlet channel 13, a water outlet member 20 pivotally mounted on the water inlet member 10 and having a water outlet channel 23 connected to the water inlet channel 13 of the water inlet member 10, and a spraying head 30 pivotally mounted on the water outlet member 20 and having a plurality of spraying holes 31 each connected to the water outlet channel 23 of the water outlet member 20.

The water inlet member 10 is connected to a water source (not shown) and has an end portion provided with a fixed disk 11. The water inlet channel 13 of the water inlet member 10 extends into the fixed disk 11 of the water inlet member 10. The fixed disk 11 of the water inlet member 10 has a central portion provided with a support tube 12. The support tube 12 of the water inlet member 10 extends in an axial direction of the fixed disk 11 of the water inlet member 10 and protrudes outwardly from the fixed disk 11. The support tube 12 of the water inlet member 10 has an inner portion provided with an inner thread 120. The fixed disk 11 of the water inlet member 10 has a periphery provided with a receiving hole 14.

The water outlet member 20 has a first end provided with a rotation disk 21 rotatably mounted on the fixed disk 11 of the water inlet member 10. The rotation disk 21 of the water outlet member 20 has a central portion provided with a rotation hole 22 rotatably mounted on the support tube 12 of the water inlet member 10. The rotation hole 22 of the water outlet member 20 extends in an axial direction of the rotation disk 21 of the water outlet member 20. The rotation disk 21 of the water outlet member 20 has a periphery provided with a plurality of positioning holes 24. A fastening bolt 60 abuts the rotation disk 21 of the water outlet member 20 and is screwed into the inner thread 120 of the support tube 12 to combine the rotation disk 21 of the water outlet member 20 and the fixed disk 11 of the water inlet member 10 together. The water outlet member 20 has a side provided with a receiving bore 26. The water outlet member 20 has a second end provided with a mounting post 27. The mounting post 27 of the water outlet member 20 has a periphery provided with an annular retaining groove 25. The water outlet channel 23 of the water outlet member 20 is connected between the rotation disk 21 and the mounting post 27 of the water outlet member 20.

The spraying head 30 has a first side provided with the spraying holes 31 and a second side provided with a pivot hole 32 pivotally mounted on the mounting post 27 of the water outlet member 20. The pivot hole 32 of the spraying head 30 is connected between the spraying holes 31 of the spraying head 30 and the water outlet channel 23 of the water outlet member 20. The pivot hole 32 of the spraying head 30 has a periphery provided with a plurality of resilient retaining hooks 34 snapped into and retained in the retaining groove 25 of the mounting post 27 so that the pivot hole 32 of the spraying head 30 is pivotable on and non-detachable from the mounting post 27 of the water outlet member 20. The second side of the spraying head 30 has a periphery provided with a plurality of positioning bores 33.

The gardening sprinkler further comprises a positioning member 40 movably mounted on the fixed disk 11 of the water inlet member 10 and detachably positioned in one of the positioning holes 24 of the rotation disk 21 to temporarily position the rotation disk 21 of the water outlet member 20 on the fixed disk 11 of the water inlet member 10, an elastic member 50 biased between the fixed disk 11 of the water inlet member 10 and the positioning member 40 to push the positioning member 40 toward the positioning holes 24 of the rotation disk 21, a positioning element 42 movably mounted on the water outlet member 20 and detachably positioned in one of the positioning bores 33 of the spraying head 30 to temporarily position the spraying head 30 on water outlet member 20, and an elastic element 52 biased between the water outlet member 20 and the positioning element 42 to push the positioning element 42 toward the positioning bores 33 of the spraying head 30. The positioning member 40 and the elastic member 50 are received in the receiving hole 14 of the fixed disk 11, and the positioning element 42 and the elastic element 52 are received in the receiving bore 26 of the water outlet member 20.

When in use, the water from the water source in turn flows through the water inlet channel 13 of the water inlet member 10, the water outlet channel 23 of the water outlet member 20 and the pivot hole 32 of the spraying head 30 and is injected outwardly from the spraying holes 31 of the spraying head 30 to sprinkle or water a plant or lawn or to wash an article.

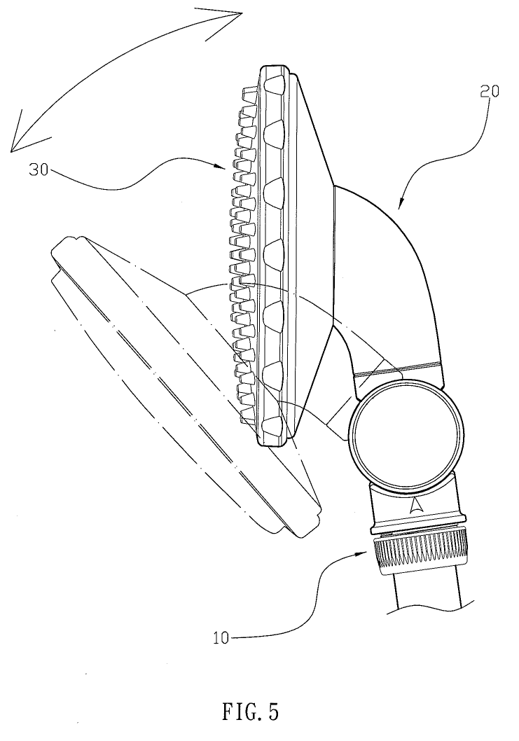

In operation, referring to FIG. 5 with reference to FIGS. 1-4, the rotation disk 21 of the water outlet member 20 is rotated relative to the fixed disk 11 of the water inlet member 10 so that the water outlet member 20 and the spraying head 30 are rotated upward and downward relative to the water inlet member 10 to adjust the angle between the spraying head 30 and the water inlet member 10 so as to adjust the upward and downward pivot angle of the spraying head 30. At this time, the positioning member 40 is positioned in one of the positioning holes 24 of the rotation disk 21 to temporarily position the rotation disk 21 of the water outlet member 20 on the fixed disk 11 of the water inlet member 10.

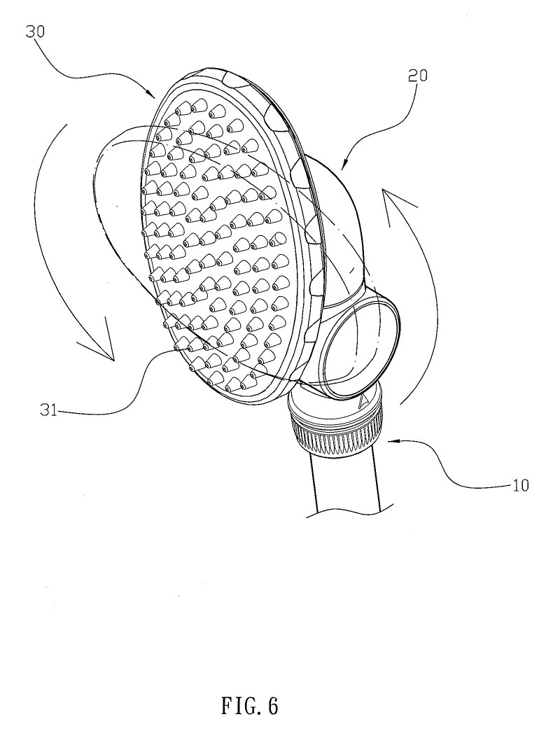

Alternatively, referring to FIG. 6 with reference to FIGS. 1-4, the pivot hole 32 of the spraying head 30 is pivoted on the mounting post 27 of the water outlet member 20 so that the spraying head 30 is swiveled relative to the water outlet member 20 to adjust the swivel angle between the spraying head 30 and the water outlet member 20 and to adjust the angle between the spraying head 30 and the water inlet member 10 so as to adjust the sprinkling pattern of the spraying head 30. At this time, the positioning element 42 is positioned in one of the positioning bores 33 of the spraying head 30 to temporarily position the spraying head 30 on water outlet member 20.

Accordingly, the water outlet member 20 is rotated relative to the water inlet member 10, and the spraying head 30 is swiveled relative to the water outlet member 20 so that the spraying head 30 is pivoted relative to the water inlet member 10 in a two-dimensional manner to greatly enhance the maneuverability of the spraying head 30 so as to facilitate a user manipulating the gardening sprinkler. In addition, the water outlet member 20 is rotated relative to the water inlet member 10 independently, and the spraying head 30 is swiveled relative to the water outlet member 20 independently so that the user can control the pivot angle and the sprinkling pattern of the spraying head 30 individually.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A gardening sprinkler, comprising:
a water inlet member having a water inlet channel;
a water outlet member pivotally mounted on the water inlet member and having a water outlet channel connected to the water inlet channel of the water inlet member;
a spraying head pivotally mounted on the water outlet member and having a plurality of spraying holes each connected to the water outlet channel of the water outlet member.

2. The gardening sprinkler of claim 1, wherein
the water inlet member has an end portion provided with a fixed disk;
the water outlet member has a first end provided with a rotation disk rotatably mounted on the fixed disk of the water inlet member.

3. The gardening sprinkler of claim 2, wherein
the fixed disk of the water inlet member has a central portion provided with a support tube;
the rotation disk of the water outlet member has a central portion provided with a rotation hole rotatably mounted on the support tube of the water inlet member.

4. The gardening sprinkler of claim 2, wherein
the rotation disk of the water outlet member has a periphery provided with a plurality of positioning holes;
the gardening sprinkler further comprises:
a positioning member movably mounted on the fixed disk of the water inlet member and detachably positioned in one of the positioning holes of the rotation disk to temporarily position the rotation disk of the water outlet member on the fixed disk of the water inlet member;
an elastic member biased between the fixed disk of the water inlet member and the positioning member to push the positioning member toward the positioning holes of the rotation disk.

5. The gardening sprinkler of claim 4, wherein
the fixed disk of the water inlet member has a periphery provided with a receiving hole;
the positioning member and the elastic member are received in the receiving hole of the fixed disk.

6. The gardening sprinkler of claim 2, wherein
the water outlet member has a second end provided with a mounting post;
the spraying head has a first side provided with the spraying holes and a second side provided with a pivot hole pivotally mounted on the mounting post of the water outlet member.

7. The gardening sprinkler of claim 6, wherein
the second side of the spraying head has a periphery provided with a plurality of positioning bores;
the gardening sprinkler further comprises:
a positioning element movably mounted on the water outlet member and detachably positioned in one of the positioning bores of the spraying head to temporarily position the spraying head on water outlet member;
an elastic element biased between the water outlet member and the positioning element to push the positioning element toward the positioning bores of the spraying head.

8. The gardening sprinkler of claim 7, wherein
the water outlet member has a side provided with a receiving bore;
the positioning element and the elastic element are received in the receiving bore of the water outlet member.

9. The gardening sprinkler of claim 6, wherein
the mounting post of the water outlet member has a periphery provided with an annular retaining groove;
the pivot hole of the spraying head has a periphery provided with a plurality of resilient retaining hooks snapped into and retained in the retaining groove of the mounting post.

10. The gardening sprinkler of claim 9, wherein the pivot hole of the spraying head is pivotable on and non-detachable from the mounting post of the water outlet member.

11. The gardening sprinkler of claim 6, wherein the water outlet channel of the water outlet member is connected between the rotation disk and the mounting post of the water outlet member.

12. The gardening sprinkler of claim 6, wherein the pivot hole of the spraying head is connected between the spraying holes of the spraying head and the water outlet channel of the water outlet member.

13. The gardening sprinkler of claim 2, wherein the water inlet channel of the water inlet member extends into the fixed disk of the water inlet member.

14. The gardening sprinkler of claim 3, wherein the support tube of the water inlet member extends in an axial direction of the fixed disk of the water inlet member.

15. The gardening sprinkler of claim 3, wherein the support tube of the water inlet member protrudes outwardly from the fixed disk.

16. The gardening sprinkler of claim 3, wherein the rotation hole of the water outlet member extends in an axial direction of the rotation disk of the water outlet member.

17. The gardening sprinkler of claim 3, wherein
the support tube of the water inlet member has an inner portion provided with an inner thread;
the gardening sprinkler further comprises:
a fastening bolt abutting the rotation disk of the water outlet member and screwed into the inner thread of the support tube to combine the rotation disk of the water outlet member and the fixed disk of the water inlet member together.
